(19) United States
(12) Patent Application Publication
(10) Pub. No.: US 2006/0285339 A1
(43) Pub. Date: Dec. 21, 2006

(54) Adjustable light source holder

(76) Inventor: William Frasier, New Bedford, MA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/156,423

(22) Filed: Jun. 20, 2005

(51) Int. Cl. F21S 8/00

(52) U.S. Cl. 362/427; 362/572; 362/581; 362/419

(57) ABSTRACT

An adjustable light source holder allowing for manipulation of a light source to surgical site through an access device in at least two planes. The adjustable light source has a connecting portion for connecting to and rotating about an access device and a mounting portion for slidably receiving the light source.

### BACKGROUND

In minimally invasive surgical procedures providing access to a variety of working spaces is critical for a successful surgical outcome. For example, in spinal surgery, access devices or retractors are used to provide access to a surgical site below the skin. Access devices exist in various configurations such as ports, expandable tubes or frames with adjustable blades. Lighting through the access device to the surgical site can be difficult. The light source may get in the way of the instruments or may not be able to reach the area the surgeon needs lit.

### SUMMARY

Disclosed herein are devices for holding and directing a light source through an access device to a desired point in the surgical site and methods of using the devices. The light source holder is used to direct light within the surgical site through an access device. The holder is adjustable to allow manipulation of the light source in more than one direction to a desired location within the surgical site. The holder may provide for a variety of adjustments of the light source with respect to the access device including rotational, translational and angular. The holder may be mounted to the retractor or to an instrument holding the retractor in place.

According to a first embodiment, an adjustable light source holder for lighting a surgical site through an access device, has a connecting portion adapted to rotate with respect to the access device, and a mounting portion having a channel extending through a portion thereof for slidably receiving a light source.

Another embodiment of a light source holder has a connecting portion adapted to connect to an access device and a mounting portion for holding a light source. The light source holder permits translational movement of the light source with respect to the access device.

Also disclosed herein is a system for providing light to a surgical site through an access device, includes a light source; a light source holder, adapted to adjust the position of the light source in two planes; and an access device.

A method of using the light source holder is also disclosed herein. The method of adjusting the direction of a light source through an access device includes positioning an access device in a patient; connecting a light source holder to the access device; inserting a light source into the light source holder; and linearly moving the light source relative to the access device to direct light to the desired location.

### BRIEF DESCRIPTION OF THE FIGURES

These and other features and advantages of the adjustable light source holder and methods disclosed herein will be more fully understood by reference to the following detailed description in conjunction with the attached drawings in which like reference numerals refer to like elements through the different views. The drawings illustrate principals of the adjustable light source holder and methods disclosed herein and, although not to scale, show relative dimensions.

FIG. 1A illustrates an adjustable light source holder according to one embodiment disclosed herein.

FIG. 1B illustrates the light source holder shown in FIG. 1A holding a light source.

FIG. 1C illustrates the adjustable light source holder of FIG. 1B mounted on an expandable access device.

FIG. 2A illustrates an alternate embodiment of an adjustable light source holder.

FIG. 2B illustrates the adjustable light source holder of FIG. 2A holding a light source and connected to a rigid arm and an access device in the form of a port.

FIG. 3A illustrates another embodiment of an adjustable light source holder and a light source.

FIG. 3B illustrates the adjustable light source holder of FIG. 3A connected to an expandable access device in the expanded position.

FIG. 3C illustrates a dovetail configuration of the adjustable light source holder and light source of FIG. 3A.

FIG. 4A illustrates an embodiment of a light source assembly including an outer sleeve component.

FIG. 4B illustrates an endview of the light source assembly shown in FIG. 4A.

FIG. 5A illustrates a perspective view of an embodiment of the outer sleeve component of the light source assembly.

FIG. 5B illustrates a cross-sectional endview of the outer sleeve component of the light source assembly shown in FIG. 5A.

### DETAILED DESCRIPTION OF EXEMPLARY EMOBDIMENTS

Certain exemplary embodiments will now be described to provide an overall understanding of the principles of the structure, function, manufacture, and use of the adjustable light source holder and methods disclosed herein. One or more examples of these embodiments are illustrated in the accompanying drawings. Those of ordinary skill in the art will understand that the adjustable light source holder and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

The articles “a” and “an” are used herein to refer to one or to more than one (i.e. to at least one) of the grammatical object of the article. By way of example, “an element” means one element or more than one element.

The terms “comprise,”“include,” and “have,” and the derivatives thereof, are used herein interchangeably as comprehensive, open-ended terms. For example, use of “comprising,”“including,” or “having” means that whatever element is comprised, had, or included, is not the only element encompassed by the subject of the clause that contains the verb.

The adjustable light holder of an illustrative embodiment may be used in spinal surgery, for example, during a discectomy or microdiscectomy procedure to remove damaged disc material from the spine, though one skilled in the art will recognize that the invention can be used with any surgical instrument in any surgical procedure that requires minimally invasive access. Examples of surgical procedures suitable for employing the adjustable light holder of the present invention include, but are not limited to, insertion of interbody fusion devices, bone anchors, fixation devices, including rods, plates and cables, artificial disks and hip stems. The light holder can be used to position any light source through an access device in any suitable procedure where additional lighting of the surgical site is needed.

The light source may include a source capable of generating and transmitting light and a guide or connection to transmit light from the source to the surgical site such as a cable carrying light transmitting elements. The light transmitting elements may be fiber optic cables or wires or other known light transmitting elements. Throughout the application the term “light source” is used to refer to the combination or assembly of components that transmit light to the surgical site. The term includes pre-assembled and unassembled light source.

The light source holder provides for manipulation of the light source in at least two planes. The light source holder allows both rotational and translational manipulation with respect to the access device creating the surgical pathway to the surgical site. In some embodiments the light source holder provides for manipulation in three planes with respect to the access device. In some embodiments the light source holder has a polyaxial joint allowing for manipulation around a spherical cone of angulation of about 120 degrees.

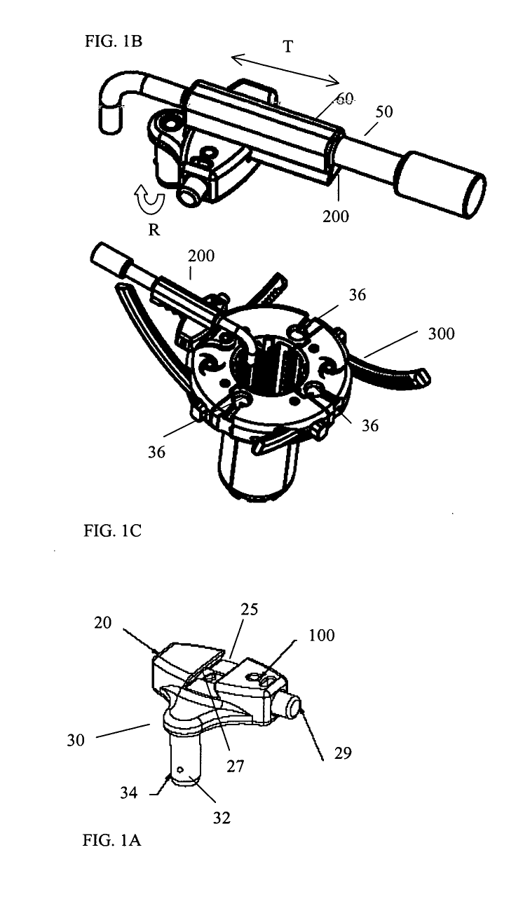

Referring to FIG. 1A, an adjustable light source holder 100 of an illustrative embodiment is shown that provides adjustability in multiple planes to direct the light to a desired location within the surgical site defined by the access device. The illustrative light source holder 100 has a mounting portion 20 configured to support a light source 200 and a connection portion 30 configured to connect to an access device 300 or other surgical instrument. The adjustable light source holder 100 is preferably formed of stainless steel or other surgical grade material. In some embodiments the light source holder 100 may be formed as a solid piece or multiple components. In one embodiment the light source holder 100 permits rotational and translational movement of the light source 200 with respect to the access device.

As illustrated in FIG. 1A, the mounting portion 20 of the light source holder 100 has a channel 25 extending therethrough. The channel is sized to hold the light source 200. The channel 25 may have a rectangular, semi-circular or dovetail shape or any other shape allowing the light source to fit within the channel and move in a linear direction depicted by arrow T in FIG. 1B. In one embodiment, the sidewall of the channel 25 may have a projection 27 for engaging the light source 200 and holding it in a selected position within the channel. A pushbutton 29 located on a side of the mounting portion 20 engages the projection 27 such that when the button is pushed, the projection retracts into the sidewall allowing the light source 50 to fit within the channel. When the pushbutton 29 is released, the projection 27 protrudes from the sidewall and engages the light source. Other examples for securing the light source within the channel include spring-loaded ball plungers or pins projecting from the inner surface of the side walls adapted to mate with a corresponding detent or slot on the light source. The corresponding shape between the channel 25 and the light source 200 provide the user with the ability to manipulate the light to the surgical site in a linear direction with respect to the access device.

The connecting portion 30 connects the light source holder 100 to the access device or the access device holder. The connecting portion 30 provides rotational manipulation of the light source with relation to the access device. In one embodiment the connecting portion 30 may be in the form of a pin 34 extending from the bottom of the light source holder 100. The pin 34 may be configured to engage a corresponding recess 36 in the base or frame of the access device. FIG. 1C illustrates the light source holder 100 holding a light source 200 and connected by the pin 34 to an expandable access device 300. The pin 34 may be generally cylindrical in shape so that the light source holder 100 may rotate around the pin depicted in FIG. 1B by arrow R. The user can adjust the direction of the light by rotating the holder around the pin. The pin 34 may further include a locking mechanism to secure the holder in a selected orientation. The locking mechanism may be a spring-loaded ball 32 positioned on the pin. Other examples of locking mechanisms may include but not be limited to a collet, snap ring, slot & pin, frictional fit or other mechanisms known to one skilled in the art may be used to secure the holder in the selected rotational orientation.

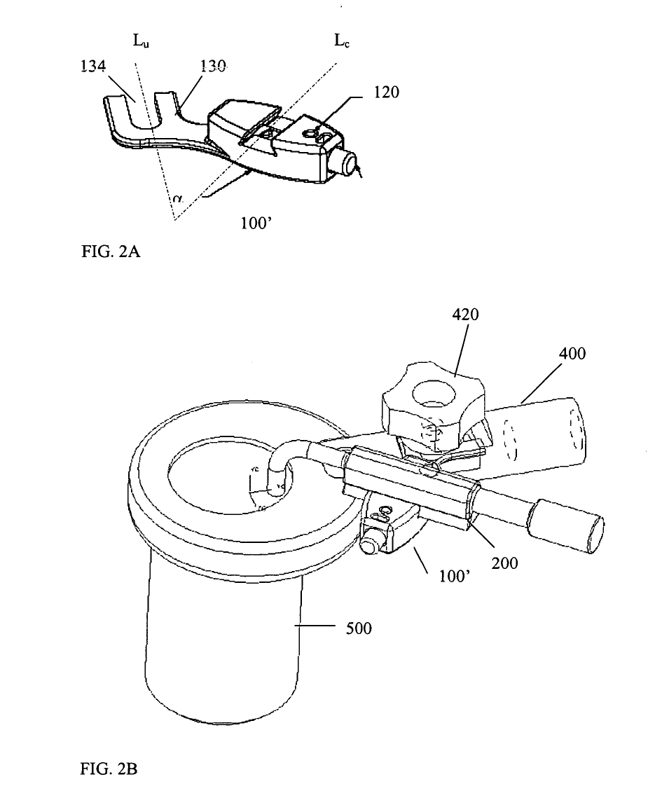

Another embodiment of a light source holder 100′ is shown in FIG. 2A. The connecting portion 130 extends from the mounting portion 120 and includes a u-shaped opening 134. The u-shaped opening 134 is configured to connect with a rigid arm attachment used with the access device or any other instrument for holding an access device. FIG. 2B illustrates light source holder 100′ connected to a rigid arm 400 and a fixed access device 500. The curvature of the opening 134 permits the light source 200 to rotate with respect to the access device 500 allowing the user to adjust the direction of the light. The longitudinal axis of the channel L_{c} and the longitudinal axis of the u-shaped opening Lᵤ intersect to form an angle α. The range of α may be between 0° and 90°. The connecting portion 130 is held in place in relation to the access device by tightening a threaded knob 420 on the rigid arm or other holding instrument.

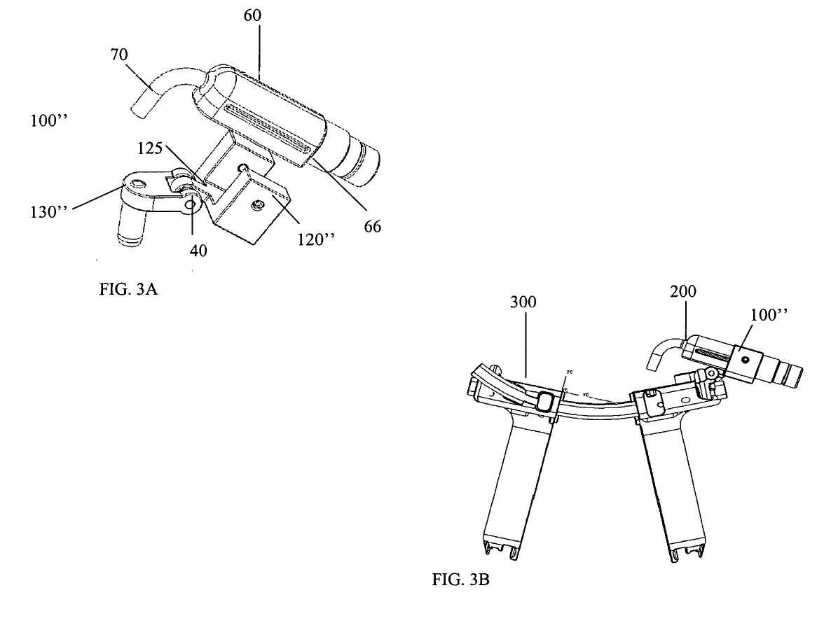

An alternate embodiment is shown in FIG. 3A. In this embodiment, the light source holder 100″ has a third plane of adjustability allowing the user to manipulate the light source 200 at an angle with respect to the access device depicted by arrow A in FIG. 3C. A hinge joint 40 is positioned between the mounting portion 120″ and the connecting portion 130″ to provide for angular adjustment. The mounting portion l20″ has a channel 125″ adapted to mate with the outer surface of the light source 200. In one embodiment the channel 125″ has a flat bottom and side walls as shown in FIG. 3A. In another embodiment, the channel 125″ may have a dovetail configuration to match a dovetail on the light source 200. An example of the corresponding dovetail shapes in the channel and light source is shown in FIG. 3C. The joint 40 may be spring-loaded to keep the mating surfaces under constant tension. The mating surfaces include surface treatment, for example, the mating surfaces may be slightly roughened, sandblasted, contain a starburst pattern or have mating teeth. The combination of the spring-loading and surface treatment allows the user to maintain the light source at a selected angular position. The user can adjust the angular orientation by overcoming the spring force to disengage the mating surfaces of the joint. As shown in FIG. 3B, the light source holder 100″ is angled with respect to the expanded access device 300 to direct the light to the position where it is needed in the surgical site.

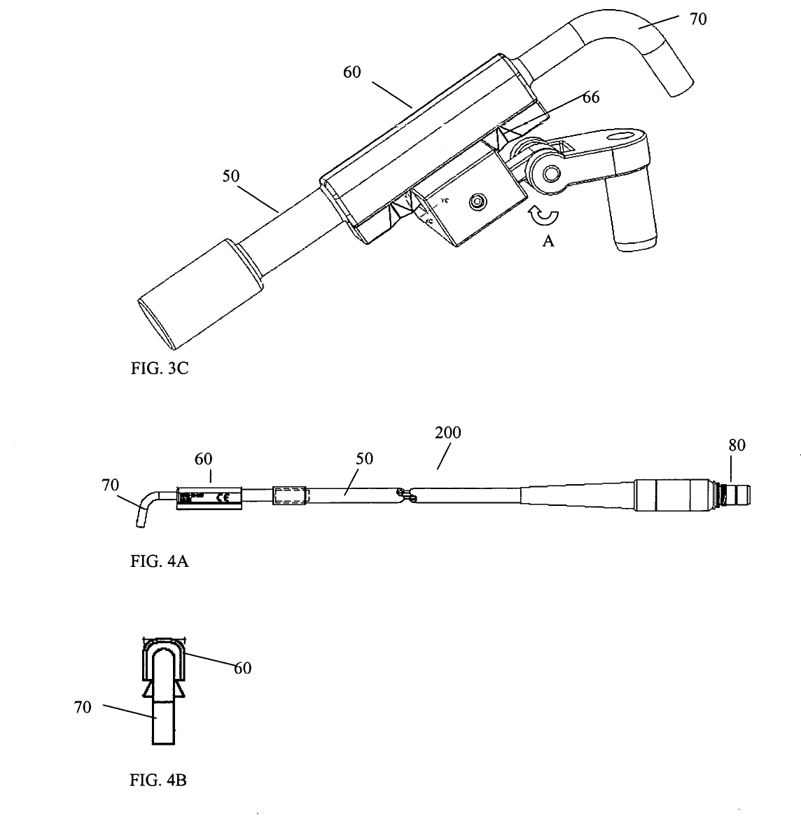

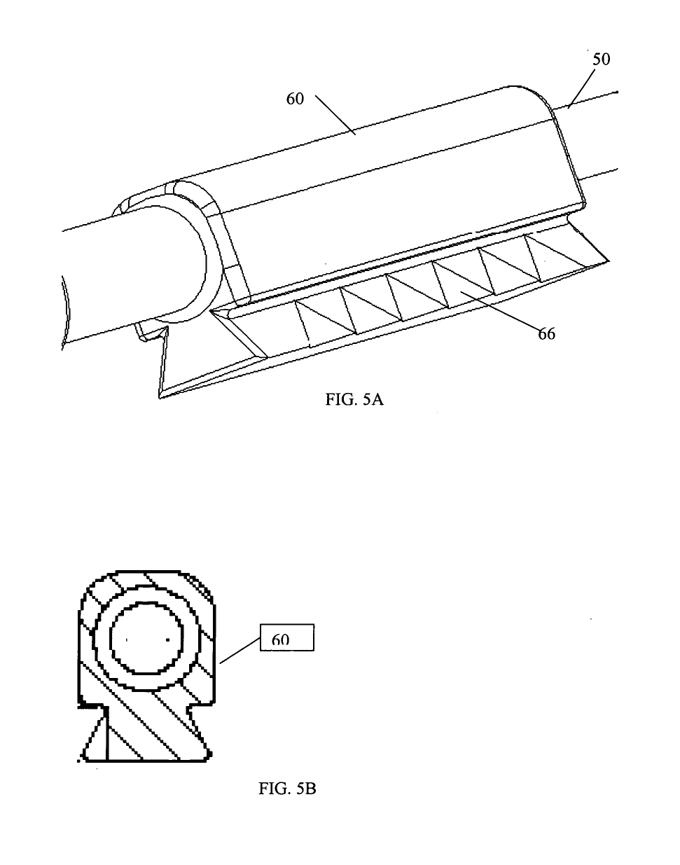

The light source 200 may include a light box, not shown, and a cable 50 for transmitting the light to the surgical site. The cable 50 may be a silicon sheath with fiber optics extending through the cable. A fitting 80 for connecting the cable 50 to the light source 200 is also considered a part of the light source. The light source 200 may further include an outer sleeve 60 adapted to fit around a portion of the cable 50 to retain the light source within the channel 25 of the light source holder 100. The outer sleeve 60 may be preassembled to the cable or be a separate component left for the user to assemble to the cable 50. The sleeve component 60 of the light source 100 has a cross-section adapted to fit within the channel 25 of the mounting portion 20 and to allow for linear movement of the light source 200 along the channel. The shape of the outer sleeve 60 may be a dovetail, semi-circular, cylindrical, rectangular or any other suitable shape that allows the light source 200 to move linearly along the channel. An outer sleeve 60 having a dovetail shape is shown in FIGS. 5A and 5B. The outer sleeve may also have a groove, detents, or notches along the side adapted to engage a projection 27 on the inner surface of the sidewall of the channel 25 for retaining the outer sleeve 60 and light source 200 within the channel at a selected position. FIG. 5A illustrates a dovetail shaped outer sleeve 60 with notches 66 for engagement with a projection 27 from the sidewall of the channel of the light source holder. The cable 50 extends through the outer sleeve 60 into a tip 70, which emits the light into the surgical site. The tip 70 may be angled, adjustable or articulating. The tip 70 may be angled between 60° and 180° from the cable 50. In the preferred embodiment the tip 70 is angled greater than 90 degrees from the cable. FIGS. 4A and 4B show a sideview and an endview from the angled tip of an assembled light source.

The access device may be expandable in many directions or be a unitary device such as a port. The access device can have any suitable cross-section, for example, circular, oval or rectilinear and is not limited to a cylindrical cross-section. A base or ring may connect the access device to a rigid arm or other instrument for maintaining the access device in a fixed position.

During a minimally invasive procedure, a surgeon may use the light source holder to provide additional light to the surgical site through an access device. Once the access device has been positioned within the patient, the surgeon connects the light source holder to the access device. The surgeon can move the light source holder in two different planes in relation to the access device to position the light at a desired location in the surgical site. The surgeon can rotate the holder about the access device and translate the light source in a linear motion with respect to the access device. The surgeon can also manipulate the light source holder to adjust the angular position of the light source with respect to the access device.

While the adjustable light source holders and methods of the present invention have been particularly shown and described with reference to the exemplary embodiments thereof, those of ordinary skill in the art will understand that various changes may be made in the form and details herein without departing from the spirit and scope of the present invention. Those of ordinary skill in the art will recognize or be able to ascertain many equivalents to the exemplary embodiments described specifically herein by using no more than routine experimentation. Such equivalents are intended to be encompassed by the scope of the present invention and the appended claims. For example, one skilled in the art will recognize that the instrument of the illustrative embodiment of the invention is not limited to use in spinal surgery and can be used with any suitable implant or procedure for any suitable orthopedic system.

It is also to be understood that the following claims are to cover all generic and specific features of the invention described herein, and all statements of the scope of the invention which, as a matter of language, might be said to fall therebetween.

1. An adjustable light source holder for lighting a surgical site through an access device, comprising:
a connecting portion adapted to rotate with respect to the access device, and a mounting portion having a channel extending through a portion thereof for slidably receiving a light source.

2. The light source holder of claim 1, wherein the channel has a dovetail configuration.

3. The light source holder of claim 1, wherein the connecting portion further comprises a pin adapted to fit within an opening on the access device.

4. The light source holder of claim 3, wherein the pin further comprises a spring-loaded ball.

5. The light source holder of claim 1, wherein the connecting portion further comprises a u-shaped opening.

6. The light source holder of claim 1, further adapted to angularly adjust the light source with respect to the access device.

7. The light source holder of claim 5, further comprising a joint for providing angular adjustment of the light source.

8. The light source holder of claim 6, wherein the joint is spring-loaded to maintain the holder in a fixed angular position.

9. The light source holder of claim 1, wherein the channel further comprises a locking mechanism adapted to lock the light source within the channel at a fixed position.

10. The light source holder of claim 9, wherein the locking mechanism is a ball plunger projecting into the channel from a sidewall of the channel.

11. The light source holder of claim 9, wherein the locking mechanism is a pin projecting from a sidewall engageable with a groove on the light source.

12. A system for providing light to a surgical site through an access device, comprising:
a light source;
a light source holder, adapted to adjust the position of the light source in two planes; and
an access device.

13. The system of claim 12 wherein the light source further comprises an adjustable tip.

14. The system of claim 12 wherein the light source holder adjusts the position of the light source rotationally and translationally with respect to the access device.

15. The system of claim 12 wherein the light source holder adjusts the position of the light source in 3 different planes.

16. The system of claim 12 wherein the access device is expandable.

17. The system of claim 12 wherein the access device is a port.

18. A light source holder comprising a connecting portion adapted to connect to an access device and a mounting portion for holding a light source, the light source holder permitting translational movement of the light source with respect to the access device.

19. The light source holder of claim 18 further comprising a channel on the mounting portion for translating the light source within the channel with respect to the access device.

20. The light source holder of claim 18 wherein the connecting portion rotatably connects the holder to the access device.

21. The light source holder of claim 20 wherein the connecting portion comprises a pin.

22. The light source holder of claim 18 further comprising a hinge joint positioned between the connecting portion and mounting portion for adjusting the angular position of the light source with respect to the access device.

23. The light source holder of claim 18 further comprising a polyaxial joint positioned between the connecting portion and the mounting portion for adjusting the angular position of the light source with respect to the access device.

24. A method of adjusting the direction of a light source through an access device comprising:
positioning an access device in a patient;
connecting a light source holder to the access device;
inserting a light source into the light source holder; and
linearly moving the light source relative to the access device to direct light to the desired location.

25. The method of claim 24 further comprising:
rotating the light source holder about the access device.

26. The method of claim 24 further comprising:
adjusting the angular position of the light source relative to the access device.

27. The method of claim 24 further comprising:
locking the light source in position within the light holder.
